(19) United States
(12) Patent Application Publication
(10) Pub. No.: US 2013/0085257 A1
(43) Pub. Date: Apr. 4, 2013

(54) METHODS FOR PRODUCING AQUEOUS DIAMINE DICARBOXYLIC ACID SALT SOLUTION AND POLYAMIDE

(71) Applicants: Yu Nitto, Chiyoda-ku (JP); Hajime Nagahara, Chiyoda-ku (JP)

(72) Inventors: Yu Nitto, Chiyoda-ku (JP); Hajime Nagahara, Chiyoda-ku (JP)

(73) Assignee: ASAHI KASEI CHEMICALS CORPORATION, Tokyo (JP)

(21) Appl. No.: 13/703,508

(22) PCT Filed: Jun. 23, 2011
(86) PCT No.: PCT/JP2011/064448

§ 371 Date: Dec. 11, 2012

(30) Foreign Application Priority Data
Jun. 23, 2010 (JP) 2010-142843

(51) Int. Cl. C08G 69/26

(52) U.S. Cl. CPC C08G 69/26
USPC 528/346; 528/347

(57) ABSTRACT

A method for producing an aqueous diamine dicarboxylic acid salt solution according to the present invention comprises a step of mixing a dicarboxylic acid diester and a diamine, wherein a mixing molar ratio of the diamine to the dicarboxylic acid diester (diamine/dicarboxylic acid diester) is 1.005 or more. In addition, a method for producing a polyamide according to the present invention comprises a step of mixing a dicarboxylic acid diester and a diamine and heating the formed aqueous diamine dicarboxylic acid salt solution to perform a polycondensation reaction of the diamine and a dicarboxylic acid, wherein a mixing molar ratio of the diamine to the dicarboxylic acid diester (diamine/dicarboxylic acid diester) is 1.005 or more.

### TECHNICAL FIELD

The present invention relates to methods for producing an aqueous diamine dicarboxylic acid salt solution and a polyamide.

### BACKGROUND ART

Since polyamides represented by polyamide 6, polyamide 66 (hereinafter, sometimes referred to as “PA6” and “PA66”, respectively), and the like are superior in molding processability, mechanical properties and chemical resistance, they are widely used as a material for various parts, such as for automobiles, electric and electronic parts, industrial materials, and daily and household articles.

In the automobile industry, as an environmental measure, there is a need for lightening the weight of an automobile body by using a metal substitute in order to reduce exhaust gases.

To respond to this need, polyamides are being increasingly used for exterior materials, interior materials and the like, and the level of the properties required of polyamide materials, such as heat resistance, intensity and appearance, is further enhanced. In particular, since the temperature in an engine room tends to be raised, there is increasingly a strong need for increasing the heat resistance of polyamide materials.

Further, in the electric and electronics industry, such as household appliances, there is a need for increasing the heat resistance of polyamide materials which are capable of withstanding an increase in melting point of a solder in order to respond to a lead-free surface-mount (SMT) solder.

Since the PA6 and PA66 polyamides have a low melting point and cannot satisfy these needs in terms of heat resistance, studies for polyamides having a high melting point have been conventionally made to thereby propose various materials.

Specifically, an aliphatic polyamide having a high melting point (hereinafter, sometimes abbreviated as “PA46”) formed from adipic acid and tetramethylenediamine and a semi-aromatic polyamide having a high melting point (hereinafter, sometimes abbreviated as “6T-based copolymer polyamide”) mainly containing terephthalic acid and hexamethylenediamine have been proposed and some of them are used in practice.

However, the PA46 has favorable moldability and heat resistance, but it has a high water absorption rate and thus problems are a remarkably large change in dimension and a remarkably high reduction in mechanical properties, due to water absorption, thereby in some cases making it impossible to satisfy the need in terms of change in dimension required in automobile applications and the like.

In addition, while the 6T-based copolymer polyamide has a low water absorbance, a high heat resistance and a high chemical resistance, it has a low fluidity, and can be insufficient in moldability and the surface appearance of a molded product and can be inferior in toughness and light resistance. Therefore, there is a demand for an improvement in applications as in exterior parts, such as in which a molded product is required for having appearance properties or in which a molded product is exposed to sunlight. The 6T-based copolymer polyamide has a large specific weight, and thus there are also demands for an improvement in lightweight properties.

Under such circumstances, as a polyamide having a high melting point, which has a different structure from the PA46 and the 6T-based copolymer polyamide, a semi-alicyclic polyamide using 1,4-cyclohexanedicarboxylic acid has been proposed (see, e.g., Patent Document 1). Patent Document 1 discloses that this semi-alicyclic polyamide is superior in light resistance, toughness, moldability and heat resistance.

With respect to a method for producing 1,4-cyclohexanedicarboxylic acid which serves as a raw material of this semi-alicyclic polyamide, some methods are known. For example, a method in which terephthalic acid is hydrogenated by a palladium catalyst to obtain 1,4-cyclohexanedicarboxylic acid, a method in which a sodium salt of terephthalic acid is hydrogenated in the presence of a ruthenium catalyst and the obtained sodium salt of 1,4-cyclohexanedicarboxylic acid is allowed to react with an acid such as hydrochloric acid to thereby obtain 1,4-cyclohexanedicarboxylic acid, and a method in which 1,4-cyclohexanedicarboxylic acid dimethyl ester (hereinafter, sometimes referred to as “DMCD”) obtained by hydrogenating terephthalic acid dimethyl ester is hydrolyzed in the presence of sulfuric acid or sodium hydroxide to obtain 1,4-cyclohexanedicarboxylic acid have been proposed (see, e.g., Patent Document 2). In these methods, 1,4-cyclohexanedicarboxylic acid isolated as a solid is obtained.

With respect to a method for producing a polyamide, a production method (1) in which a solution of a mixture of a dicarboxylic acid and a diamine in water is used as a starting raw material is generally adopted (see, e.g., Patent Document 1). In this type of reaction, water is added to 1,4-cyclohexanedicarboxylic acid and 2-methylpentamethylenediamine to form a uniformly mixed liquid, and the water added is removed and water as a by-product of the reaction is removed to thereby form an amide bond for performing polycondensation.

On the other hand, a production method (2) in which a mixture of a dicarboxylic acid ester and a diamine is used as a starting raw material is also known. For example, a mixture of 1,4-cyclohexanedicarboxylic acid dimethyl ester and hexamethylenediamine is charged into an autoclave and heated to remove methanol as a by-product of the reaction, thereby forming an amide bond for performing polymerization (see, e.g., Patent Document 3).

In addition, as a production method (3) in which a solution of a mixture of a dicarboxylic acid diester and a diamine in water is used as a starting raw material, a production method in which dicarboxylic acid dimethyl ester and hexamethylenediamine are used (see, e.g., Patent Document 4). Herein, in a method in which sebacic acid dimethyl ester and hexamethylenediamine are used, methanol is removed to obtain a polyamide intermediate and then a polycondensation reaction is allowed to progress.

### CITATION LIST

### Patent Documents

Patent Document 1: International Publication No. WO2002/048239
Patent Document 2: Japanese Patent Laid-Open No. 2005-330239
Patent Document 3: International Publication No. WO2010/117098
Patent Document 4: Japanese Patent Laid-Open No. 57-80426

### SUMMARY OF INVENTION

### Problems to be Solved by Invention

In all the above-described methods for producing 1,4-cyclohexanedicarboxylic acid, water is used as a solvent at a high temperature for performing a reaction, and 1,4-cyclohexanedicarboxylic acid which is a product is isolated by removing water.

On the other hand, in the case of the production method (1) in which 1,4-cyclohexanedicarboxylic acid is used as a raw material to produce a polyamide, 1,4-cyclohexanedicarboxylic acid and a diamine are mixed in equimolar amounts in the presence of water to obtain an aqueous salt solution, and the aqueous salt solution is heated under a high pressure condition to distill off water as a solvent of the aqueous salt solution and water generated by polycondensation of the diamine and the dicarboxylic acid by means of distillation, thereby allowing the reaction to progress.

Namely, in a process of producing 1,4-cyclohexanedicarboxylic acid, a product is obtained as a mixture containing water. Therefore, water must be removed in order to isolate 1,4-cyclohexanedicarboxylic acid. Furthermore, when this 1,4-cyclohexanedicarboxylic acid is used as a raw material to perform polymerization of a polyamide, water is again added for performing the reaction, thereby causing a problem in that operations overlap and are complicated as a whole of the process of producing a polyamide.

On the other hand, in the case of the method (2) in which 1,4-cyclohexanedicarboxylic acid dimethyl is used as a raw material to produce a polyamide, 1,4-cyclohexanedicarboxylic acid and the diamine are mixed and methanol is removed to thereby allow a polymerization reaction to progress. Although this reaction can be simplified in light of not using water, it has a problem in that 1,4-cyclohexanedicarboxylic acid and the diamine are removed at the same time as removing methanol in the reaction to cause a difference in molar ratio between a dicarboxylic acid component and a diamine component in a polyamide, thereby making it difficult to enhance the degree of polymerization.

On the other hand, in the case of the production method (3) in which the dicarboxylic acid dimethyl ester and hexamethylenediamine are used, the dicarboxylic acid dimethyl ester and hexamethylenediamine are mixed in equimolar amounts to perform hydrolysis of the dicarboxylic acid dimethyl ester. Such a hydrolysis reaction of the dicarboxylic acid dimethyl ester rapidly progresses at the initial stage of the reaction and the dicarboxylic acid dimethyl ester as a raw material is gradually consumed, but as a result, the dicarboxylic acid monomethyl ester remains. The remaining monomethyl ester has a higher vapor pressure than a dicarboxylic acid. Therefore, in the case where a reaction temperature is raised to a temperature higher than the melting point of a polyamide having a melting point of 280° C. or more in order to polymerize the polyamide, the dicarboxylic acid monomethyl ester and the diamine go outside the system in the form of vapor to thereby remarkably cause a problem in that a difference in molar ratio between a dicarboxylic acid component and a diamine component in the polyamide is generated to make it difficult the degree of polymerization.

Then, an object of the present invention is to provide a method for producing an aqueous diamine dicarboxylic acid salt solution and a method for producing a polyamine which are capable of simplify the whole process of producing a polyamide.

### Means for Solving Problems

The present inventors have intensively studied in order to solve the above problems, and as a result, have found that the above problems can be solved by hydrolyzing a dicarboxylic acid diester in the presence of a diamine usable for producing a polyamide to produce a dicarboxylic acid and at the same time to obtain a salt with a diamine, thereby leading to complete the present invention.

Namely, the present invention is as follows.

(1)

A method for producing an aqueous diamine dicarboxylic acid salt solution, comprising a step of mixing a dicarboxylic acid diester and a diamine, wherein a mixing molar ratio of the diamine to the dicarboxylic acid diester (diamine/dicarboxylic acid diester) is 1.005 or more.

(2)

The method for producing the aqueous diamine dicarboxylic acid salt solution according to (1), wherein the dicarboxylic acid diester is a terephthalic acid diester or a cyclohexanedicarboxylic acid diester.

(3)

The method for producing the aqueous diamine dicarboxylic acid salt solution according to (1) or (2), wherein the diamine comprises any diamine selected from the group consisting of 1,6-diaminohexane, 1,5-diaminopentane, 1,9-diaminononane, 1,10-diaminodecane and 2-methyl-1,5-diaminopentane.

(4)

The method for producing the aqueous diamine dicarboxylic acid salt solution according to any one of (1) to (3), wherein a trialkylamine is further mixed with the dicarboxylic acid diester and the diamine.

(5)

A method for producing a polyamide, using the aqueous diamine dicarboxylic acid salt solution obtained in the method for producing the aqueous diamine dicarboxylic acid salt solution according to any one of (1) to (4).

(6)

The method for producing the polyamide according to (5), wherein the polyamide has a melting point of 280° C. or more.

(7)

The method for producing the polyamide according to (5) or (6), comprising:

a step of obtaining a mixture having a molar ratio of the diamine to the dicarboxylic acid (diamine/dicarboxylic acid) of 0.95 to 1.05 by adding a dicarboxylic acid to the aqueous diamine dicarboxylic acid salt solution, and

a step of performing a polycondensation reaction of the diamine and the dicarboxylic acid in the mixture obtained in the above step.

(8)

A method for producing a polyamide, comprising:

a step of forming an aqueous diamine dicarboxylic acid salt solution by mixing a dicarboxylic acid diester and a diamine, and

a step of performing a polycondensation reaction of the diamine and the dicarboxylic acid by heating the aqueous diamine dicarboxylic acid salt solution formed in the above step,

wherein in the step of forming the aqueous diamine dicarboxylic acid salt solution, a mixing molar ratio of the diamine to the dicarboxylic acid diester (diamine/dicarboxylic acid diester) is 1.005 or more.

(9)

The method for producing the polyamide according to (8), wherein in the aqueous diamine dicarboxylic acid salt solution formed in the above step, a total molar amount of the dicarboxylic acid diester and a dicarboxylic acid monoester is 1 mol % or less based on a total molar amount of the dicarboxylic acid, the dicarboxylic acid diester and the dicarboxylic acid monoester.

(10)

The method for producing the polyamide according to (8) or (9), further comprising a step of obtaining a mixture having a molar ratio of the diamine to the dicarboxylic acid (diamine/dicarboxylic acid) of 0.95 to 1.05 by adding a dicarboxylic acid to the aqueous diamine dicarboxylic acid salt solution for use in the step of performing the polycondensation reaction.

(11)

The method for producing the polyamide according to any one of (8) to (10), wherein in the step of forming the aqueous diamine dicarboxylic acid salt solution, a mixing molar ratio of the diamine to the dicarboxylic acid diester (diamine/dicarboxylic acid diester) is 1.01 to 2.00.

### Advantageous Effects of Invention

According to the production method of the present invention, a high quality aqueous diamine dicarboxylic acid salt solution which is suitable as a raw material for producing a polyamide and has an extremely small content of impurities can be produced by a simple process.

By producing the aqueous diamine dicarboxylic acid salt solution according to the production method of the present invention, the effects of making it possible to omit a step of isolating a dicarboxylic acid, making it possible to simplify a process and facility, and having an extreme advantage in industry are achieved.

### MODE FOR CARRYING OUT INVENTION

Hereinafter, an embodiment for carrying out the present invention (hereinafter, referred to as “present embodiment”) will be described in detail.

The present invention is not limited to the following embodiment, which can be variously modified and carried out within the scope of the present invention.

### (Method for Producing Aqueous Diamine Dicarboxylic Acid Salt Solution)

A method for producing an aqueous diamine dicarboxylic acid salt solution of the present embodiment comprises a step of mixing a dicarboxylic acid diester and a diamine, wherein a mixing molar ratio of the diamine to the dicarboxylic acid diester (diamine/dicarboxylic acid diester) is 1.005 or more.

### (Dicarboxylic Acid Diester)

The dicarboxylic acid diester is a hydrocarbon compound having two ester groups as substituents.

With respect to the hydrocarbon compound, examples of an aliphatic hydrocarbon compound include n-butane, n-pentane, n-hexane, n-nonane, n-decane, n-dodecane, 2-methylpentane, 2,5-dimethylhexane and 2-methyloctane.

Examples of an alicyclic hydrocarbon compound include cyclopentane, cyclohexane and decahydronaphthalene.

Examples of a hydrocarbon compound having an aromatic ring include benzene, toluene, xylene, naphthalene and anthracene.

The ester group can be represented by the following chemical formula (I).

—COOR (I)

Wherein, R is selected from an alkyl group having 1 to 20 carbon atoms, an aryl group having 6 to 20 carbon atoms and an arylalkyl group having 7 to 20 carbon atoms.

Example of the alkyl group having 1 to 20 carbon atoms include a methyl group, an ethyl group, an isopropyl group and a n-butyl group.

Example of the aryl group having 6 to 20 carbon atoms include a phenyl group and a p-tolyl group.

Example of the arylalkyl group having 7 to 20 carbon atoms include a benzyl group and a phenethyl group.

R is preferably an alkyl group, and particularly preferably a methyl group.

The dicarboxylic acid diester is suitably a terephthalic acid diester or a cyclohexanedicarboxylic acid diester. In the case where such dicarboxylic acid diesters are used, a polyamide having a high heat resistance can be easily obtained as a polyamide obtained by using the aqueous diamine dicarboxylic acid salt solution, regardless of the type of diamine.

The cyclohexanedicarboxylic acid diester is a compound having two ester groups in the cyclohexane skeleton.

The ester groups may be at any of the 1,2-positions, the 1,3-positions and the 1,4-positions.

The cyclohexanedicarboxylic acid diester is a compound having two ester groups in the cyclohexane skeleton.

The cyclohexanedicarboxylic acid diester is preferably 1,4-cyclohexanedicarboxylic acid dimethyl ester, 1,3-cyclohexanedicarboxylic acid dimethyl ester, 1,4-cyclohexanedicarboxylic acid diethyl ester, 1,2-cyclohexanedicarboxylic acid di-n-butyl ester or the like, and more preferably 1,4-cyclohexanedicarboxylic acid dimethyl ester.

1,4-cyclohexanedicarboxylic acid dimethyl ester is easily obtained by hydrogenating terephthalic acid dimethyl ester under a high temperature and high pressure condition in the presence of, for example, a palladium catalyst.

### (Diamine)

The diamine is a hydrocarbon compound having two amino groups as substituents.

The diamine may be used singly or may be used as a mixture of two or more diamines.

The hydrocarbon compound constituting the diamine for use in the production method of the present embodiment is preferably an aliphatic hydrocarbon compound having 1 to 20 carbon atoms, an alicyclic hydrocarbon compound having 5 to 20 carbon atoms or a hydrocarbon compound having an aromatic ring having 6 to 20 carbon atoms.

Examples of the aliphatic hydrocarbon compound include n-butane, n-pentane, n-hexane, n-nonane, n-decane, n-dodecane, 2-methylpentane, 2,5-dimethylhexane and 2-methyloctane.

Examples of the alicyclic hydrocarbon compound include cyclopentane, cyclohexane, cyclooctane and decahydronaphthalene.

Examples of the hydrocarbon compound having an aromatic ring include benzene, toluene, xylene, naphthalene and anthracene.

The amino group may be at any position of the hydrocarbon compound.

The diamine for use in the production method of the present embodiment is preferably a primary diamine or a secondary diamine.

Although a tertiary diamine can allow the reaction to effectively progress upon hydrolysis of the dicarboxylic acid diester because of having a high reaction rate, it cannot serve as a raw material for a polyamide.

The diamine for use in the production method of the present embodiment is preferably a primary diamine. The reason for this is because while a secondary diamine has a higher reaction rate than a primary diamine, a primary diamine is more suitable as a raw material for a polyamide from the viewpoint of stability of a polyamide.

Specific examples of the diamine for use in the production method of the present embodiment include 1,5-diaminopentane, 1,6-diaminohexane, 1,9-diaminononane, 1,10-diaminodecane, 1,12-diaminododecane, 2-methyl-1,5-diaminopentane, 2-methyl-1,8-diaminooctane, 1,4-diaminocyclohexane, 1,3-bis(aminomethyl)cyclohexane, metaxylenediamine and 3,5-diaminotoluene.

In particular, 1,5-diaminopentane, 1,6-diaminohexane, 1,9-diaminononane, 1,10-diaminodecane, 2-methyl-1,5-diaminopentane and 2-methyl-1,8-diaminooctane are preferable, and 1,6-diaminohexane, 1,10-diaminodecane and 2-methyl-1,5-diaminopentane are more preferable.

### (Water)

Water is used as a solvent in the aqueous diamine dicarboxylic acid salt solution of the present embodiment. Water is added to the dicarboxylic acid diester and the diamine in advance. In this case, the resultant may be separated into two layers, oil and water, or may be uniform, depending on the type of the dicarboxylic acid diester and the amount of water, and such both cases may be acceptable. The amount of water can be arbitrarily selected as long as a mixture of the diamine and the dicarboxylic acid is not precipitated and is a uniform aqueous solution, and the weight of water is preferably in the range of 0.2 to 10, more preferably in the range of 0.3 to 5, and further preferably in the range of 0.5 to 2, when the sum of the weights of the diamine and the dicarboxylic acid is assumed to be 1. In the case where the weight of water is less than 0.2, the diamine dicarboxylic acid is precipitated particularly at a low temperature, and in the case where the weight of water is more than 10, deterioration in efficiency is caused when a polyamide is produced by using the aqueous diamine dicarboxylic acid salt solution as a raw material because the amount of the polyamide obtained with respect to the size of polymerization reactor is reduced.

(Reaction with Dicarboxylic Acid Diester and Diamine)

In the method for producing the aqueous diamine dicarboxylic acid salt solution of the present embodiment, the above-described dicarboxylic acid diester and the above-described diamine are mixed, heated and allowed to react in the presence of water. It is preferable to remove an alcohol as a by-product and optionally water which is a solvent by distillation in a reactor. Water corresponding to water removed by distillation may be added during the reaction.

In the course of the reaction, a lactam or an co-aminocarboxylic acid can be arbitrarily added.

Examples of the lactam include, but not limited to, the following: pyrrolidone, caprolactam, undecalactam and dodecalactam.

On the other hand, examples of the ω-aminocarboxylic acid include, but not limited to, the following: ω-amino fatty acids which are open-ring compounds of the above lactams by means of water.

It is to be noted that the respective lactams or ω-aminocarboxylic acids may be used singly or in combination of two or more thereof.

### (Mixing Ratio of Diamine to Dicarboxylic Acid Diester)

A mixing molar ratio of the diamine to the dicarboxylic acid diester (diamine/dicarboxylic acid diester) is 1.005 or more, preferably 1.01 or more, more preferably 1.03 or more, and further preferably 1.05 or more. The mixing molar ratio (diamine/dicarboxylic acid diester) is preferably 3.00 or less, more preferably 2.50 or less, and further preferably 2.00 or less.

In the case where the mixing molar ratio (diamine/dicarboxylic acid diester) is less than 1.005, the reaction more slowly progresses as the hydrolysis reaction of the dicarboxylic acid diester progresses, and unreacted reactants which are not hydrolyzed even if taking a time, such as the dicarboxylic acid diester and a dicarboxylic acid monoester, remain. In the case where the mixing molar ratio (diamine/dicarboxylic acid diester) is more than 3.00, the hydrolysis of the dicarboxylic acid diester rapidly progresses, but it is necessary to adjust the numbers of moles of the diamine and the dicarboxylic acid to be about equimolar as described later when the obtained aqueous diamine dicarboxylic acid salt solution is used to produce a polyamide, and thus the numbers of moles to be adjusted are made larger to thereby cause deterioration in efficiency.

In addition, if the dicarboxylic acid diester and the dicarboxylic acid monoester are incorporated in the aqueous diamine dicarboxylic acid salt solution, they inhibit polymerization upon producing a polyamide, thereby not enhancing the degree of polymerization as expected. A total molar amount of the dicarboxylic acid diester and the dicarboxylic acid monoester in the aqueous diamine dicarboxylic acid salt solution is preferably 1 mol % or less, more preferably 0.5 mol % or less, and further preferably 0.3 mol % or less, based on a total molar amount of the dicarboxylic acid, the dicarboxylic acid diester and the dicarboxylic acid monoester.

It is to be noted that the total molar amount of the dicarboxylic acid diester and the dicarboxylic acid monoester in the aqueous diamine dicarboxylic acid salt solution can be measured by a method described in Examples described later.

In the case where the aqueous diamine dicarboxylic acid salt solution obtained by the production method of the present embodiment is used as a raw material for producing a polyamide, the diamine or the dicarboxylic acid is preferably added to the obtained the aqueous diamine dicarboxylic acid salt solution so that the numbers of moles of the diamine and the dicarboxylic acid are within a specified range.

For example, in the case where the reaction according to the production method of the present embodiment is performed with an excessive amount of the diamine, the dicarboxylic acid is preferably added to the obtained aqueous diamine dicarboxylic acid salt solution. When the numbers of moles of the diamine and the dicarboxylic acid are within a specified range, the polymerization reaction of a polyamide to be performed later efficiently progresses to thereby make it possible to enhance the degree of polymerization of a polyamide. In the case where the dicarboxylic acid is added to the aqueous diamine dicarboxylic acid salt solution to prepare a mixture, a molar ratio of the diamine to the dicarboxylic acid (diamine/dicarboxylic acid) in the mixture is preferably 0.95 to 1.05, more preferably 0.98 to 1.04, and further preferably 0.99 to 1.03.

When the aqueous diamine dicarboxylic acid salt solution is produced, water is added for performing the reaction, and an amount of water per mol of the dicarboxylic acid diester is preferably 2 to 20, more preferably 2 to 15, and further preferably 4 to 10, in terms of the molar ratio.

The amount of water is 20 or less in terms of the molar ratio to thereby make it possible to prevent the concentration of the aqueous salt solution from being too lowered and to maintain a high productivity. The amount of water is 2 or more in terms of the molar ratio to thereby make it possible to complete the reaction in a short time.

### (Trialkylamine)

In the method for producing the aqueous diamine dicarboxylic acid salt solution of the present embodiment, a trialkylamine can be further mixed when the dicarboxylic acid diester and the diamine are reacted. The trialkylamine is mixed to thereby tend to make it possible to enhance the reaction rate of hydrolysis of the dicarboxylic acid diester and to make smaller the ratio of the diamine to the dicarboxylic acid diester in terms of the amount.

The trialkylamine for use in the present embodiment refers to a nitrogen compound in which no hydrogen atom is attached to a nitrogen atom, such as a tertiary amine and a cyclic amine. The trialkylamine for use in the present embodiment is represented by “NR₃”, wherein N denotes a nitrogen atom, and R denotes an aliphatic hydrocarbon group, an alicyclic hydrocarbon group or an aromatic hydrocarbon group, wherein R may be the same one or may be a combination of more than one, two or three, or R may be taken together to form a cyclic structure.

Examples of the trialkylamine include trimethylamine, triethylamine, tri-n-butylamine, diethylmethylamine, pyridine and 2-methylpyridine.

The trialkylamine may be partially or entirely removed together with an alcohol or water by distillation during the reaction. The trialkylamine may also remain in the process of producing the polyamide in which the aqueous salt solution is used as a raw material, or may also be removed together with water in the process of producing the polyamide.

With respect to the production of the aqueous diamine dicarboxylic acid salt solution, while any reaction temperature and any reaction pressure can be used as long as an alcohol as a by-product can be distilled and removed in the reaction, the reaction temperature is preferably 50 to 150° C. and further preferably 80 to 120° C., and the reaction pressure is preferably from −0.1 MPa (gauge pressure) of a vacuum state to 0.1 MPa (gauge pressure).

As the reaction progresses by carrying out the method for producing the aqueous diamine dicarboxylic acid salt solution of the present embodiment, an alcohol corresponding to the ester is generated.

This alcohol can be returned to a reaction vessel or can be extracted from the reaction system by distillation.

During removing the alcohol, water can also be removed by distillation at the same time. Water may also be added to the system.

Since the alcohol is removed to thereby allow the equilibrium of the reaction to incline to generate an alcohol, the reaction by the method for producing the aqueous diamine dicarboxylic acid salt solution of the present embodiment can be allowed to advantageously progress. In the reaction of the method for producing the aqueous diamine dicarboxylic acid salt solution of the present embodiment, water is required and thus water may be appropriately returned or added to the reaction system.

### (Method for Producing Polyamide)

A method for producing a polyamide of the present embodiment comprises a step of forming an aqueous diamine dicarboxylic acid salt solution by mixing a dicarboxylic acid diester and a diamine, and a step of performing a polycondensation reaction of the diamine and the dicarboxylic acid by heating the aqueous diamine dicarboxylic acid salt solution formed in the above step, wherein in the step of forming the aqueous diamine dicarboxylic acid salt solution, a mixing molar ratio of the diamine to the dicarboxylic acid diester (diamine/dicarboxylic acid diester) is 1.005 or more.

In the method for producing the polyamide of the present embodiment, the polycondensation reaction refers to a generally known dehydration condensation reaction of a diamine and a dicarboxylic acid. The polyamide obtained by performing the dehydration condensation is one in which a diamine component and a component derived from a dicarboxylic acid are alternately linked via an amide bond.

In the method for producing the polyamide of the present embodiment, the aqueous diamine dicarboxylic acid salt solution obtained in the method for producing the aqueous diamine dicarboxylic acid salt solution described above is preferably used.

Namely, the method for producing the polyamide of the present embodiment preferably comprises a step of forming the aqueous diamine dicarboxylic acid salt solution according to the above method for producing the aqueous diamine dicarboxylic acid salt solution, and a step of performing a polycondensation reaction of the diamine and the dicarboxylic acid by heating the aqueous diamine dicarboxylic acid salt solution obtained in the above step.

In the step of forming the aqueous diamine dicarboxylic acid salt solution of the method for producing the polyamide of the present embodiment, the mixing molar ratio of the diamine to the dicarboxylic acid diester (diamine/dicarboxylic acid diester) is 1.005 or more, preferably 1.01 or more, more preferably 1.03 or more, and further preferably 1.05 or more. The mixing molar ratio (diamine/dicarboxylic acid diester) is preferably 3.00 or less, more preferably 2.50 or less, and further preferably 2.00 or less. The mixing molar ratio (diamine/dicarboxylic acid diester) is within the above range to thereby make it possible to allow the hydrolysis reaction of the dicarboxylic acid diester to rapidly progress, and to suppress the amount of unreacted reactants such as a dicarboxylic acid diester and a dicarboxylic acid monoester remaining in the step of forming the aqueous diamine dicarboxylic acid salt solution. In addition, this makes it possible to reduce the operation of adding a dicarboxylic acid in order to adjust the numbers of moles of the diamine and the dicarboxylic acid to be about equimolar as described later when performing the step of performing a polycondensation reaction of the diamine and the dicarboxylic acid, and to enhance the productivity of a polyamide.

In the aqueous diamine dicarboxylic acid salt solution formed in the above step of the method for producing the polyamide of the present embodiment, the total molar amount of the dicarboxylic acid diester and the dicarboxylic acid monoester is preferably 1 mol % or less, more preferably 0.5 mol % or less, and further preferably 0.3 mol % or less, based on the total molar amount of the dicarboxylic acid, the dicarboxylic acid diester and the dicarboxylic acid monoester. In the aqueous diamine dicarboxylic acid salt solution, the total molar amount of the dicarboxylic acid diester and the dicarboxylic acid monoester is within the above range to thereby tend to efficiently obtain a polyamide having a high degree of polymerization.

The method for producing the polyamide of the present embodiment preferably further comprises a step of obtaining a mixture having a molar ratio of the diamine to the dicarboxylic acid (diamine/dicarboxylic acid) of 0.95 to 1.05 by adding a dicarboxylic acid to the aqueous diamine dicarboxylic acid salt solution for use in the step of performing the polycondensation reaction. The molar ratio of the diamine to the dicarboxylic acid (diamine/dicarboxylic acid) in the mixture is more preferably 0.98 to 1.04 and further preferably 0.99 to 1.03. The molar ratio of the diamine to the dicarboxylic acid (diamine/dicarboxylic acid) in the mixture is within the above range to thereby allow the polycondensation reaction of the diamine and the dicarboxylic acid in the mixture to efficiently progress, thereby making it possible to obtain a polyamide having a high degree of polymerization.

In the step of forming the aqueous diamine dicarboxylic acid salt solution of the method for producing the polyamide of the present embodiment, preferably, a trialkylamine is further mixed to the dicarboxylic acid diester and the diamine. The trialkylamine is mixed to thereby tend to make it possible to enhance the reaction rate of hydrolysis of the dicarboxylic acid diester and to make smaller the ratio of the diamine to the dicarboxylic acid diester in terms of the amount.

The carboxylic acid diester, the diamine and the trialkylamine for use in the method for producing the polyamide of the present embodiment are the same as those for use in the above method for producing the aqueous diamine dicarboxylic acid salt solution.

The dicarboxylic acid diester for use in the step of forming the aqueous diamine dicarboxylic acid salt solution is preferably a terephthalic acid diester or a cyclohexanedicarboxylic acid diester. The terephthalic acid diester can be easily obtained by oxidizing paraxylene which is a basically petroleum chemistry product. In particular, since terephthalic acid dimethyl has been traditionally used as a raw material for polyethylene terephthalate (PET), it is industrially produced and widely distributed, and thus can be easily available. The cyclohexanedicarboxylic acid diester, which is obtained by subjecting terephthalic acid dimethyl to hydrogen reduction, is also easily available. A polyamide obtained from the aqueous diamine dicarboxylic acid salt solution obtained by using such a dicarboxylic acid diester tends to have a higher melting point.

The diamine for use in the step of forming the aqueous diamine dicarboxylic acid salt solution preferably includes any diamine selected from the group consisting of 1,6-diaminohexane, 1,5-diaminopentane, 1,9-diaminononane, 1,10-diaminodecane and 2-methyl-1,5-diaminopentane. Such a diamine is easily available and a polyamide having a high crystallinity tends to be obtained from a diamine dicarboxylic acid using such a diamine.

The melting point of the polyamide obtained by the method for producing the polyamide of the present embodiment is preferably 280° C. or more, preferably 285 to 380° C., and preferably 290 to 360° C. The polyamide having the melting point within the above range can be utilized as a metal substitute material in the automobile industry and can also be utilized as a material having a high heat resistance responding to a surface-mount technique (SMT technique) in the electric and electronics industry, and tends to have a high heat stability upon polymerization, extrusion and molding in the molten state.

It is to be noted that the melting point of the polyamide can be measured by a method described in Examples described later.

The method for producing the polyamide of the present embodiment comprises the step of forming the aqueous diamine dicarboxylic acid salt solution by mixing the above dicarboxylic acid diester and the diamine, and the step of performing a polycondensation reaction of the diamine and the dicarboxylic acid by heating the aqueous diamine dicarboxylic acid salt solution formed in the above step. In the step of forming the aqueous diamine dicarboxylic acid salt solution, a mixing molar ratio of the diamine to the dicarboxylic acid diester (diamine/dicarboxylic acid diester) is controlled to be within the above specified range to thereby make it possible to use a known method in the polycondensation reaction and in a step of increasing a degree of polymerization of the polyamide. For example, preferably, the method for producing the polyamide of the present embodiment further comprises the step of increasing the degree of polymerization of the polyamide.

Examples of the method for producing the polyamide of the present embodiment include various methods exemplified below:

1) a method of heating the aqueous diamine dicarboxylic acid salt solution formed in the above step and subjecting it to polymerization while maintaining the molten state,
2) a method of increasing the degree of polymerization of the polyamide obtained by a hot melt polymerization method while maintaining the solid state at a temperature equal to or lower than the melting point,
3) a method of heating the aqueous diamine dicarboxylic acid salt solution formed in the above step and further melting the precipitated prepolymer again by an extruder such as a kneader to increase the degree of polymerization, and
4) a method of heating the aqueous diamine dicarboxylic acid salt solution formed in the above step and further maintaining the precipitated prepolymer in the solid state at a temperature equal to or lower than the melting point of the polyamide to increase the degree of polymerization.

Examples of the method for increasing the degree of polymerization of the polyamide to increase the melting point of the polyamide in the method for producing the polyamide of the present embodiment include a method of raising the temperature upon heating and/or making the heating time longer. In the case where such a method is performed, coloration of the polyamide due to heating and a reduction in the tensile elongation due to thermal degradation may be caused. In addition, a remarkable reduction in the increasing rate of a molecular weight may be caused.

In the method for producing the polyamide of the present embodiment, the polymerization mode may be a batch mode or a continuous mode.

A polymerization apparatus for use in the method for producing the polyamide of the present embodiment is not particularly limited, and examples thereof include known apparatuses such as an autoclave-type reactor, a tumbler-type reactor, and an extruder-type reactor such as a kneader.

Specific examples of the method for producing the polyamide of the present embodiment include, but not particularly limited to, a batch mode hot melt polymerization method described below.

The batch mode hot melt polymerization method is, for example, as follows. The aqueous diamine dicarboxylic acid salt solution formed in the above step is concentrated to a concentration of about 65 to 90% by mass in a concentration tank operated at a temperature of 110 to 180° C. and a pressure of about 0.035 to 0.6 MPa (gauge pressure) to obtain a concentrated solution. Then, the concentrated solution is transferred to an autoclave, and continued to be heated until the pressure in a container reaches about 1.5 to 5.0 MPa (gauge pressure). Thereafter, the pressure is kept at about 1.5 to 5.0 MPa (gauge pressure) while evacuating water and/or a gaseous component, and the pressure is dropped to the atmospheric pressure (gauge pressure: 0 MPa) at the point when the temperature reaches about 250 to 350° C. After being dropped to the atmospheric pressure, the pressure is reduced as required to thereby make it possible to effectively remove water as a by-product. Thereafter, the pressure is raised by an inert gas such as nitrogen to extrude a polyamide melt as a strand. The strand is cooled and cut to obtain a pellet.

Specific examples of the method for producing the polyamide of the present embodiment include, but not particularly limited to, a continuous mode hot melt polymerization method described below.

The continuous mode hot melt polymerization method is, for example, as follows. The aqueous diamine dicarboxylic acid salt solution formed in the above step is preliminarily heated to about 40 to 100° C. in a container of a preliminary apparatus, then transferred to a concentration layer/reactor and concentrated to a concentration of about 70 to 90% at a pressure of about 0.1 to 0.5 MPa (gauge pressure) and a temperature of about 200 to 270° C. to obtain a concentrated solution. The concentrated solution is discharged to a flusher kept at a temperature of about 200 to 350° C., and thereafter, the pressure is dropped to the atmospheric pressure (gauge pressure: 0 MPa). After being dropped to the atmospheric pressure, the pressure is reduced as required. Thereafter, a polyamide melt is extruded to be formed into a strand, and cooled and cut to be formed into a pellet.

The polyamide obtained in the production method of the present embodiment can be used and subjected to known molding methods, such as press molding, injection molding, gas-assisted injection molding, welding molding, extrusion molding, blow molding, film molding, hollow molding, multilayer molding, and melt spinning to obtain various molded products.

### EXAMPLES

Hereinafter, the present invention will be specifically described with reference to Examples and Comparative Examples, but is not limited to the following examples.

### (Raw Material)

(1) 1,4-cyclohexanedicarboxylic acid dimethyl (1,4-DMCD): a reagent produced by Wako Pure Chemical Industries, Ltd. was used.
(2) 1,2-cyclohexanedicarboxylic acid diethyl ester (1,2-DECD): a reagent produced by Tokyo Chemical Industry Co., Ltd. was used.
(3) Terephthalic acid dimethyl (DMT): a reagent produced by Wako Pure Chemical Industries, Ltd. was used.
(4) Terephthalic acid diethyl (DET): a reagent produced by Tokyo Chemical Industry Co., Ltd. was used.
(5) Sebacic acid dimethyl (DMC10D): a reagent produced by Tokyo Chemical Industry Co., Ltd. was used.
(6) 1,6-diaminohexane (C6DA): a reagent produced by Wako Pure Chemical Industries, Ltd. was used.
(7) 1,10-diaminodecane (C10DA): a reagent produced by Tokyo Chemical Industry Co., Ltd. was used.
(8) 2-methylpentamethylenediamine (MC5DA): a reagent produced by Sigma-Aldrich Co., LLC (2-methyl-1,5-diaminopentane) was used.
(9) 1,9-diaminononane (C9DA): a reagent produced by Sigma-Aldrich Co., LLC was used.
(10) Sulfuric acid (96%): a reagent produced by Wako Pure Chemical Industries, Ltd. was used.
(11) Sodium hydroxide: a reagent produced by Wako Pure Chemical Industries, Ltd. was used.
(12) Tri-n-butylamine (TBA): a reagent produced by Wako Pure Chemical Industries, Ltd. was used.
(13) Pyridine (PY): a reagent produced by Wako Pure Chemical Industries, Ltd. was used.
(14) Distilled water: a reagent produced by Wako Pure Chemical Industries, Ltd. was used.
(15) 1,4-cyclohexanedicarboxylic acid (1,4-CHDA): a reagent produced by Tokyo Chemical Industry Co., Ltd. was used.
(16) Terephthalic acid (TPA): a reagent produced by Wako Pure Chemical Industries, Ltd. was used.

### (Evaluation Method)

Hereinafter, evaluation methods of products in Examples and Comparative Examples described later will be described.

### <Conversion of Diester>

Gas chromatography analysis was performed in an apparatus, GC-14A (manufactured by Shimadzu Corporation), provided with a DB-5 column and an FID detector, to determine a change in the amount of a diester before and after the reaction by an internal reference method.

### <Yield of Dicarboxylic Acid>

In the case where a dicarboxylic acid was isolated, it was washed with distilled water and subjected to vacuum drying and then weighed to determine the yield.

### <Purity of Dicarboxylic Acid>

A portion of an aqueous salt solution was collected, and water was distilled off while heating at 80° C. under a reduced pressure to obtain a salt (solid). The obtained salt or dicarboxylic acid was dissolved in hexafluoroisopropanol deuteride, and subjected to a ¹H-NMR analysis by an NMR apparatus of 400 MHz to determine a difference in the integral value of a purity of 99.9% or more from that of a dicarboxylic acid.

### <Amount of Ester in Aqueous Salt Solution>

A portion of an aqueous salt solution was collected, and water was distilled off while heating at 80° C. under a reduced pressure to obtain a salt (solid). The obtained salt was dissolved in hexafluoroisopropanol deuteride, and subjected to a ¹H-NMR analysis by an NMR apparatus of 400 MHz to calculate the integral values of the peak of an ester group and the peak derived from a carboxylic acid to thereby determine an amount of an ester in the aqueous salt solution ((total molar amount of dicarboxylic acid diester and dicarboxylic acid monoester)/(total molar amount of dicarboxylic acid, dicarboxylic acid diester and dicarboxylic acid monoester)×100) in terms of the molar percentage.

### <Impurity (Na)>

Water was distilled off while heating an aqueous salt solution at 80° C. under a reduced pressure to obtain a salt (solid). The obtained salt or dicarboxylic acid was subjected to an ICP-MS analysis to identify an impurity (Na).

### <Impurity (S)>

Water was distilled off while heating an aqueous salt solution at 80° C. under a reduced pressure to obtain a salt (solid). The obtained salt or dicarboxylic acid was analyzed by ion chromatography to identify an impurity (S).

### <Melting Point Tm2 of Polyamide>

A melting point Tm2 (° C.) of a polyamide was measured as follows according to JIS-K7121 using Diamond-DSC manufactured by PERKIN-ELMER.

First, under a nitrogen atmosphere, about 10 mg of a sample was heated to a temperature of 300 to 350° C. at a temperature rise rate of 20° C./min depending on the melting point of the sample. The temperature at the endothermic peak (melting peak) which appeared in this temperature rise was defined as Tm1 (° C.). After the temperature was kept in the molten state at the maximum temperature in the temperature rise for 2 minutes, it was dropped to 30° C. at a temperature drop rate of 20° C./min, and held at 30° C. for 2 minutes. Thereafter, the maximum peak temperature of the endothermic peak (melting peak) which appeared in the temperature rise at a temperature rise rate of 20° C./min as described above was defined as the melting point Tm2 (° C.), and the total peak area was defined as the heat quantity of fusion ΔH (J/g). Herein, an area having a ΔH of 1 J/g or more was determined as a peak and, if there were a plurality of peaks, the endothermic peak temperature at the maximum ΔH was defined as the melting point Tm2 (° C.). For example, in the case where there were two endothermic peak temperatures, one endothermic peak temperature of 295° C., ΔH=20 J/g, and another endothermic peak of 325° C., ΔH=5 J/g, the melting point Tm2 (° C.) was 325° C.

### <Relative Viscosity ηr of Polyamide at 25° C.>

Measurement of the relative viscosity ηr of a polyamide at 25° C. was carried out according to JIS-K6810. Specifically, 98% sulfuric acid was used to prepare a solution of a concentration of 1% (proportion of (1 g of polyamide)/(100 mL of 98% sulfuric acid)) and the relative viscosity ηr was measured under a temperature condition of 25° C.

### Example 1

### Production of Aqueous Salt Solution

Into a 300 mL three-necked glass flask equipped with a thermometer, a distillation tube and a condenser tube, 40 g of 1,4-cyclohexanedicarboxylic acid dimethyl, 35 g of 1,6-hexamethylenediamine and 72 g of distilled water were added to obtain a mixed liquid.

Under the atmospheric pressure, the mixed liquid was heated in an oil bath while being continuously distilled so that the temperature thereof reached 100° C.

The reaction was performed for 4 hours while adding the volumetric amount of distilled water corresponding to the distilled amount to the three-necked flask, thereby obtaining an aqueous 1,6-hexamethylenediamine 1,4-cyclohexanedicarboxylic acid salt solution.

A portion of the mixed liquid in the flask was collected and subjected to a GC analysis, and the conversion of 1,4-cyclohexanedicarboxylic acid dimethyl was more than 99.9%.

The salt obtained from the aqueous salt solution was subjected to an NMR analysis, and the purity of 1,4-cyclohexanedicarboxylic acid was 98%.

Both the amount of an impurity (S) and the amount of an impurity (Na) in the salt were less than 0.1 ppm.

The amounts charged and the analysis results of the aqueous salt solution were shown in the following Table 1.

### <Production of Polyamide>

The aqueous salt solution was used to produce a polyamide by a hot melt polymerization method as follows.

To the obtained aqueous 1,6-hexamethylenediamine 1,4-cyclohexanedicarboxylic acid salt solution, 17.2 g of 1,4-cyclohexanedicarboxylic acid was added while confirming the pH by a pH meter, thereby preparing an aqueous neutralized diamine cyclohexanedicarboxylic acid salt solution suitable as a raw material for a polyamide.

The obtained aqueous solution was charged into an autoclave having an internal volume of 500 mL (manufactured by Nitto Kouatsu Co., Ltd.), and kept warm until the liquid temperature (internal temperature) reached 50° C., to replace the content of the autoclave with nitrogen. The liquid temperature was continuously raised from about 50° C. by heating until the pressure in a tank of the autoclave reached about 2.5 kg/cm² as a gauge pressure (hereinafter, all the pressures in the tank being designated as a gauge pressure). The heating was continued while removing water to the outside of the system in order to keep the pressure in the tank at about 2.5 kg/cm², thereby concentrating the aqueous solution to a concentration of about 85%. The removal of water was stopped, and the heating was continued until the pressure in the tank reached about 30 kg/cm². The heating was continued until reaching 330° C. (final reaction temperature—50° C.) while removing water to the outside of the system in order to keep the pressure in the tank at about 30 kg/cm². After the liquid temperature was raised to 340° C. (final reaction temperature—40° C.), the pressure in the tank was dropped over 60 minutes until reaching the atmospheric pressure (gauge pressure: 0 kg/cm²) while continuing the heating.

Thereafter, the temperature of a heater was adjusted so that the final reaction temperature of the resin temperature (liquid temperature) reached 380° C. While the resin temperature was kept, the pressure in the tank was reduced to 370 torr by a vacuum apparatus and maintained for 10 minutes. Thereafter, the inside of the autoclave was pressurized to about 0.2 kg/cm² by nitrogen, and then the autoclave was taken out from the heater and cooled. The autoclave was cooled to room temperature and then the produced polyamide was taken out from the autoclave while being ground. The obtained polyamide was analyzed based on the above measurement method. The analysis results of the polyamide were shown in Table 1.

### Examples 2, 3 and 4

The types and the amounts of diamines, the amounts of distilled water, the amounts of additional dicarboxylic acids, the final reaction temperatures upon producing a polyamide, and the like were changed to those described in the following Table 1.

Other conditions were the same as in Example 1 to perform the production of aqueous salt solutions and the production of polyamides.

The amounts charged, the reaction temperatures, the analysis results of the aqueous salt solutions and the analysis results of the polyamides were shown in the following Table 1.

### Example 5

The type and the amount of a diester, the type and the amount of a diamine, the amount of distilled water, the final reaction temperature upon producing a polyamide, and the like were changed to those described in the following Table 1.

No dicarboxylic acid was added upon producing a polyamide.

Furthermore, 3.7 g of tri-n-butylamine as a trialkylamine was added upon producing an aqueous salt solution.

Other conditions were the same as in Example 1 to perform the production of an aqueous salt solution and the production of a polyamide.

The amounts charged, the reaction temperature, the analysis results of the aqueous salt solution and the analysis results of the polyamide were shown in the following Table 1.

### Example 6

The type and the amount of a diester, the type and the amount of a diamine, the amount of distilled water, the amount of an additional dicarboxylic acid, the final reaction temperature upon producing a polyamide, and the like were changed to those described in the following Table 1.

Furthermore, 1.9 g of pyridine as a trialkylamine was added upon producing an aqueous salt solution.

Other conditions were the same as in Example 1 to perform the production of an aqueous salt solution and the production of a polyamide.

The amounts charged, the reaction temperature, the analysis results of the aqueous salt solution and the analysis results of the polyamide were shown in the following Table 1.

### Examples 7 and 8

The types and the amounts of diesters, the types and the amounts of diamines, the amounts of distilled water, the types and the amounts of additional dicarboxylic acids, the final reaction temperatures upon producing a polyamide, and the like were changed to those described in the following Table 1.

Other conditions were the same as in Example 1 to perform the production of aqueous salt solutions and the production of polyamides.

The amounts charged, the reaction temperatures, the analysis results of the aqueous salt solutions and the analysis results of the polyamides were shown in the following Table 1.

### Comparative Example 1

### Production of Aqueous Salt Solution

Into a 500 mL autoclave equipped with a thermometer, a distillation tube and a condenser tube, 46 g of sebacic acid dimethyl, 23 g of 1,6-hexamethylenediamine and 108 g of distilled water were added to obtain a mixed liquid.

The mixed liquid was heated in the closed system for 3 hours so that the internal temperature of the autoclave reached 130° C. Then, it was heated under the atmospheric pressure while being continuously distilled at 100° C.

The reaction was performed for 4 hours while adding the volumetric amount of distilled water corresponding to the distilled amount to the autoclave, thereby obtaining an aqueous 1,6-hexamethylenediamine sebacic acid salt solution.

A portion of the mixed liquid in the autoclave was collected and subjected to a GC analysis, and the conversion of sebacic acid dimethyl was 99.5%.

The salt obtained from the aqueous salt solution was subjected to an NMR analysis, and the purity of sebacic acid was 97%.

Both the amount of an impurity (S) and the amount of an impurity (Na) in the salt were less than 0.1 ppm.

The amounts charged and the analysis results of the aqueous salt solution were shown in the following Table 1.

### <Production of Polyamide>

The aqueous salt solution was used to produce a polyamide by a hot melt polymerization method as follows.

A polyamide was produced in the same manner as in Example 1 except that the aqueous salt solution was charged into an autoclave having an internal volume of 500 mL (manufactured by Nitto Kouatsu Co., Ltd.) without adding a dicarboxylic acid and the final reaction temperature was changed to 270° C.

The obtained polyamide was analyzed based on the above measurement method. The analysis results of the polyamide were shown in Table 1.

### Comparative Example 2

The type and the amount of a diester, the type and the amount of a diamine, the amount of distilled water, the final reaction temperature upon producing a polyamide, and the like were changed to those described in the following Table 1.

Other conditions were the same as in Comparative Example 1 to perform the production of an aqueous salt solution and the production of a polyamide.

The amounts charged, the reaction temperature, the analysis results of the aqueous salt solution and the analysis results of the polyamide were shown in the following Table 1.

### Comparative Example 3

Into a 300 mL three-necked glass flask equipped with a thermometer, a distillation tube and a condenser tube, 40 g of 1,4-cyclohexanedicarboxylic acid dimethyl, 2.0 g of sulfuric acid and 108 g of distilled water were added to obtain a mixed liquid.

Under the atmospheric pressure, the mixed liquid was heated in an oil bath while being continuously distilled so that the temperature thereof reached 100° C.

The reaction was performed for 10 hours while adding the volumetric amount of distilled water corresponding to the distilled amount to the three-necked flask, thereby obtaining 1,4-cyclohexanedicarboxylic acid.

The mixed liquid in the flask was subjected to a GC analysis, and the conversion of 1,4-cyclohexanedicarboxylic acid dimethyl was more than 99.9%.

The obtained mixed solution was cooled to 10° C., and the precipitated white solid was recovered by filtration.

This solid was washed with distilled water, and dried at 80° C. under a reduced pressure.

The obtained solid was subjected to an NMR analysis, and the purity of 1,4-cyclohexanedicarboxylic acid was 99%.

The amount of an impurity (S) and the amount of an impurity (Na) in the carboxylic acid were 0.7 ppm and less than 0.1 ppm, respectively.

The amounts charged and the analysis results of the aqueous salt solution were shown in the following Table 1.

### Comparative Example 4

Into a 300 mL glass three-necked flask equipped with a thermometer and a reflux tube, 40 g of 1,4-cyclohexanedicarboxylic acid dimethyl, 17.6 g of sodium hydroxide and 72 g of distilled water were added to obtain a mixed liquid.

Under the atmospheric pressure, the mixed liquid was heated in an oil bath while being continuously distilled so that the temperature thereof reached 100° C.

Thus, a solution of a sodium salt of 1,4-cyclohexanedicarboxylic acid in water was obtained.

The mixed liquid in the flask was subjected to a GC analysis, and the conversion of 1,4-cyclohexanedicarboxylic acid dimethyl was more than 99.9%.

The obtained mixed solution was cooled to 10° C. and about 30 mL of 35% hydrochloric acid was added thereto, and the precipitated white solid was recovered by filtration.

This solid was washed with distilled water, and dried at 80° C. under a reduced pressure.

The obtained solid was subjected to an NMR analysis, and the purity of 1,4-cyclohexanedicarboxylic acid was 99%.

The amount of an impurity (S) and the amount of an impurity (Na) in the salt were less than 0.1 ppm and 320 ppm, respectively.

The amounts charged and the analysis results of the aqueous salt solution were shown in the following Table 1.

TABLE 1

| | Example 1 | Example 2 | Example 3 | Example 4 | Example 5 | Example 6 |
|---|---|---|---|---|---|---|
| <Production conditions of | | | | | | |
| aqueous salt solution> | | | | | | |
| Diester | 1,4-DMCD | 1,4-DMCD | 1,4-DMCD | 1,4-DMCD | 1,2-DECD | 1,4-DMCC |
| | 40 g | 40 g | 40 g | 40 g | 46 g | 40 g |
| Diamine or catalyst | C6DA | C10DA | MC5DA | MC5DA | C9DA | MC5DA |
| | 35 g | 41 g | 26 g | 24 g | 32 g | 24 g |
| Molar ratio of | 1.50 | 1.20 | 1.10 | 1.05 | 1.01 | 1.05 |
| diamine/diester | | | | | | |
| Water | 72 g | 108 g | 72 g | 72 g | 36 g | 36 g |
| Trialkylamine | — | — | — | — | TBA | PY |
| | — | — | — | — | 3.7 g | 1.9 g |
| Reaction time | 4 h | 4 h | 5 h | 6 h | 6 h | 6 h |
| <Analysis of aqueous salt | | | | | | |
| solution> | | | | | | |
| Conversion of diester | >99.9% | >99.9% | >99.9% | >99.9% | >99.9% | >99.9% |
| Yield of dicarboxylic acid | — | — | — | — | — | — |
| Purity of dicarboxylic acid | 98% | 98% | 98% | 98% | 98% | 98% |
| Amount of ester in | 0.1 mol % | 0.1 mol % | 0.1 mol % | 0.1 mol % | 0.1 mol % | 0.1 mol % |
| aqueous salt solution | | | | | | |
| Impurity (Na) | <0.1 ppm | <0.1 ppm | <0.1 ppm | <0.1 ppm | <0.1 ppm | <0.1 ppm |
| Impurity (S) | <0.1 ppm | <0.1 ppm | <0.1 ppm | <0.1 ppm | <0.1 ppm | <0.1 ppm |
| <Production conditions of | | | | | | |
| polyamide> | | | | | | |
| Additional dicarboxylic | 1,4-CHDA | 1,4-CHDA | 1,4-CHDA | 1,4-CHDA | — | 1,4-CHDA |
| acid upon polymerization | 17.2 g | 6.9 g | 3.4 g | 1.7 g | — | 1.7 g |
| Molar ratio of | 1.02 | 1.02 | 1.03 | 1.02 | 1.01 | 1.03 |
| diamine/dicarboxylic acid | | | | | | |
| Final reaction | 380° C. | 340° C. | 340° C. | 340° C. | 320° C. | 340° C. |
| temperature | | | | | | |
| <Analysis of polyamide> | | | | | | |
| Melting point Tm2 (° C.) | 366 | 320 | 325 | 325 | 295 | 323 |
| Relative viscosity ηr | 2.18 | 2.16 | 2.14 | 2.14 | 2.09 | 2.09 |
| | | | Comparative | Comparative | Comparative | Comparative |
| | Example 7 | Example 8 | Example 1 | Example 2 | Example 3 | Example 4 |
| <Production conditions of | | | | | | |
| aqueous salt solution> | | | | | | |
| Diester | DMT | DET | DMC10D | 1,4-DMCD | 1,4-DMCD | 1,4-DMCD |
| | 39 g | 44 g | 46 g | 40 g | 40 g | 40 g |
| Diamine or catalyst | C9DA | C10DA | C6DA | MC5DA | Sulfuric acid | Sodium |
| | | | | | | hydroxide |
| | 38 g | 69 g | 23 g | 23 g | 2 g | 18 g |
| Molar ratio of | 1.20 | 2.00 | 1.00 | 1.00 | — | — |
| diamine/diester | | | | | | |
| Water | 72 g | 108 g | 108 g | 72 g | 108 g | 72 g |
| Trialkylamine | — | — | — | — | — | — |
| | — | — | — | — | — | — |
| Reaction time | 5 h | 6 h | 4 h | 4 h | 10 h | 2 h |
| <Analysis of aqueous salt | | | | | | |
| solution> | | | | | | |
| Conversion of diester | >99.9% | >99.9% | 99.5% | 99.5% | >99.9% | >99.9% |
| Yield of dicarboxylic acid | — | — | — | — | 93% | 70% |
| Purity of dicarboxylic acid | 98% | 98% | 97% | 96% | 99% | 99% |
| Amount of ester in | 0.1 mol % | 0.1 mol % | 2 mol % | 3 mol % | 0.3 mol % | 0.2 mol % |
| aqueous salt solution | | | | | | |
| Impurity (Na) | <0.1 ppm | <0.1 ppm | <0.1 ppm | <0.1 ppm | <0.1 ppm | 320 ppm |
| Impurity (S) | <0.1 ppm | <0.1 ppm | <0.1 ppm | <0.1 ppm | 0.7 ppm | <0.1 ppm |
| <Production conditions of | | | | | | |
| polyamide> | | | | | | |
| Additional dicarboxylic | TPA | TPA | — | — | — | — |
| acid upon polymerization | 6.6 g | 33.2 g | — | — | — | — |
| Molar ratio of | 1.03 | 1.03 | 1.00 | 1.00 | — | — |
| diamine/dicarboxylic acid | | | | | | |
| Final reaction | 340° C. | 340° C. | 270° C. | 340° C. | — | — |
| temperature | | | | | | |
| <Analysis of polyamide> | | | | | | |
| Melting point Tm2 (° C.) | 310 | 305 | 226 | 323 | — | — |
| Relative viscosity ηr | 2.12 | 2.10 | 1.98 | 1.87 | — | — |

According to Examples 1 to 8, an aqueous diamine dicarboxylic acid salt solution suitable for producing a polyamide could be produced from a dicarboxylic acid diester in a single reaction vessel by a simple process.

It was found that the obtained aqueous diamine dicarboxylic acid salt solution is high quality and has small amounts of impurities such as S and Na.

It was also found that a polyamide obtained by a polycondensation reaction of the aqueous diamine dicarboxylic acid salt solution as a raw material has a high melting point and at the same time a sufficiently high molecular weight.

The present application is based on Japanese Patent Application No. 2010-142843 filed on Jun. 23, 2010, the content of which is herein incorporated by reference.

### INDUSTRIAL APPLICABILITY

The production method of the present invention has industrial applicabilities as a technique for producing a raw material, which is capable of simplifying a process of producing a polyamide, and as a technique for efficiently producing a polyamide.

1. A method for producing an aqueous diamine dicarboxylic acid salt solution, comprising a step of mixing a dicarboxylic acid diester and a diamine, wherein a mixing molar ratio of the diamine to the dicarboxylic acid diester (diamine/dicarboxylic acid diester) is 1.005 or more.

2. The method for producing the aqueous diamine dicarboxylic acid salt solution according to claim 1, wherein the dicarboxylic acid diester is a terephthalic acid diester or a cyclohexanedicarboxylic acid diester.

3. The method for producing the aqueous diamine dicarboxylic acid salt solution according to claim 1, wherein the diamine comprises any diamine selected from the group consisting of 1,6-diaminohexane, 1,5-diaminopentane, 1,9-diaminononane, 1,10-diaminodecane and 2-methyl-1,5-diaminopentane.

4. The method for producing the aqueous diamine dicarboxylic acid salt solution according to claim 1, wherein a trialkylamine is further mixed with the dicarboxylic acid diester and the diamine.

5. A method for producing a polyamide, using the aqueous diamine dicarboxylic acid salt solution obtained in the method for producing the aqueous diamine dicarboxylic acid salt solution according to claim 1.

6. The method for producing the polyamide according to claim 5, wherein the polyamide has a melting point of 280° C. or more.

7. The method for producing the polyamide according to claim 5, comprising:
a step of obtaining a mixture having a molar ratio of the diamine to the dicarboxylic acid (diamine/dicarboxylic acid) of 0.95 to 1.05 by adding a dicarboxylic acid to the aqueous diamine dicarboxylic acid salt solution, and
a step of performing a polycondensation reaction of the diamine and the dicarboxylic acid in the mixture obtained in the above step.

8. A method for producing a polyamide, comprising:
a step of forming an aqueous diamine dicarboxylic acid salt solution by mixing a dicarboxylic acid diester and a diamine, and
a step of performing a polycondensation reaction of the diamine and the dicarboxylic acid by heating the aqueous diamine dicarboxylic acid salt solution formed in the above step,
wherein in the step of forming an aqueous diamine dicarboxylic acid salt solution, a mixing molar ratio of the diamine to the dicarboxylic acid diester (diamine/dicarboxylic acid diester) is 1.005 or more.

9. The method for producing the polyamide according to claim 8, wherein in the aqueous diamine dicarboxylic acid salt solution formed in the above step, a total molar amount of the dicarboxylic acid diester and a dicarboxylic acid monoester is 1 mol % or less based on a total molar amount of the dicarboxylic acid, the dicarboxylic acid diester and the dicarboxylic acid monoester.

10. The method for producing the polyamide according to claim 8, further comprising a step of obtaining a mixture having a molar ratio of the diamine to the dicarboxylic acid (diamine/dicarboxylic acid) of 0.95 to 1.05 by adding a dicarboxylic acid to the aqueous diamine dicarboxylic acid salt solution for use in the step of performing the polycondensation reaction.

11. The method for producing the polyamide according to claim 8, wherein in the step of forming the aqueous diamine dicarboxylic acid salt solution, a mixing molar ratio of the diamine to the dicarboxylic acid diester (diamine/dicarboxylic acid diester) is 1.01 to 2.00.

12. The method for producing the aqueous diamine dicarboxylic acid salt solution according to claim 2, wherein the diamine comprises any diamine selected from the group consisting of 1,6-diaminohexane, 1,5-diaminopentane, 1,9-diaminononane, 1,10-diaminodecane and 2-methyl-1,5-diaminopentane.

13. The method for producing the aqueous diamine dicarboxylic acid salt solution according to claim 2, wherein a trialkylamine is further mixed with the dicarboxylic acid diester and the diamine.

14. The method for producing the polyamide according to claim 6, comprising:
a step of obtaining a mixture having a molar ratio of the diamine to the dicarboxylic acid (diamine/dicarboxylic acid) of 0.95 to 1.05 by adding a dicarboxylic acid to the aqueous diamine dicarboxylic acid salt solution, and
a step of performing a polycondensation reaction of the diamine and the dicarboxylic acid in the mixture obtained in the above step.

15. The method for producing the polyamide according to claim 9, further comprising a step of obtaining a mixture having a molar ratio of the diamine to the dicarboxylic acid (diamine/dicarboxylic acid) of 0.95 to 1.05 by adding a dicarboxylic acid to the aqueous diamine dicarboxylic acid salt solution for use in the step of performing the polycondensation reaction.

16. The method for producing the polyamide according to claim 9, wherein in the step of forming the aqueous diamine dicarboxylic acid salt solution, a mixing molar ratio of the diamine to the dicarboxylic acid diester (diamine/dicarboxylic acid diester) is 1.01 to 2.00.
